(19) United States
(12) Patent Application Publication
(10) Pub. No.: US 2015/0301641 A1
(43) Pub. Date: Oct. 22, 2015

(54) QUALITY SOUND GENERATION USING ACOUSTIC ACTUATORS

(71) Applicants: Andrew Thomas SULTENFUSS, Leander, TX (US); Mitchell Anthony MARKOW, Hutto, TX (US)

(72) Inventors: Andrew Thomas SULTENFUSS, Leander, TX (US); Mitchell Anthony MARKOW, Hutto, TX (US)

(21) Appl. No.: 14/256,297

(22) Filed: Apr. 18, 2014

(51) Int. Cl. G06F 3/043

(52) U.S. Cl. CPC G06F 3/043

(57) ABSTRACT

A flat panel display, such a display included in an information handling system, may have at least one acoustic actuator bonded thereto. The acoustic actuator may be driven by an audio signal and may result in acoustic fields being radiated by the flat panel display. The acoustic actuator may transmit acoustical energy through the flat panel display to an opposite face, which may result in high sound quality by generating an enhanced direct acoustic field that a user experiences.

### BACKGROUND

1. Field of the Disclosure

This disclosure relates generally to information handling systems and, more particularly, to quality sound generation using acoustic actuators.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Flat-panel displays, which may be liquid crystal displays (LCDs), are commonly employed for portable information handling systems configured in the form of laptop, notebook, netbook, tablet, desktop, and/or all-in-one computers, among others, as well as personal smart phones. For example, the flat panel display of a typical laptop computer is mounted within a display housing that is hingeably attached to a base housing that contains the keyboard for the notebook computer. Recently various designs for portable information handling systems have been introduced that combine conventional laptop and tablet functionality, also referred to herein as “tablet-laptop” systems, and may include a touch panel integrated into the flat panel display.

In many conventional information handling systems, speakers may be included at a location primarily chosen for manufacturability rather than acoustical performance. For example, when a conventional laptop system is used with a flat panel display open, an acoustic quality of the sound generated may not meet user expectations.

### SUMMARY

In one aspect, a disclosed flat panel display includes an acoustic actuator enabled to receive an input signal and output acoustical energy corresponding to the input signal. The acoustic actuator may be bonded to a first face of an external cover of the flat panel display. The external cover may transmit at least some of the acoustical energy received from the acoustic actuator to a second face of the flat panel display. The second face may be an opposite face with respect to the first face.

Other disclosed aspects include an information handling system including a flat panel display, and a method for quality sound generation using acoustic actuators.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system;

FIG. 2 is an image of selected elements of an embodiment of a flat panel display with acoustic actuators;

FIG. 3 is a block diagram of selected elements of an embodiment of acoustic fields emanating from a flat panel display;

FIGS. 4A, 4B, 4C, 4D, 4E, and 4F are block diagrams of selected elements of embodiments of flat panel displays with acoustic actuators;

FIG. 5 is a block diagram of selected elements of an embodiment of a flat panel display; and

FIG. 6 is flowchart depicting selected elements of an embodiment of a method for quality sound generation using acoustic actuators in a flat panel display.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

As noted previously, certain flat panel displays used with information handling systems, such as with laptop systems, tablet-laptop systems, personal smart phones, tablets, desktop systems, and/or all-in-one desktop systems (i.e., an information handling system with an integrated flat panel display), may include speakers for sound generation, which may exhibit poor sound quality due to placement of the speakers. The inventors of the present application have discovered a method and system for quality sound generation using acoustic actuators integrated within a flat panel display, as will be described in further detail herein.

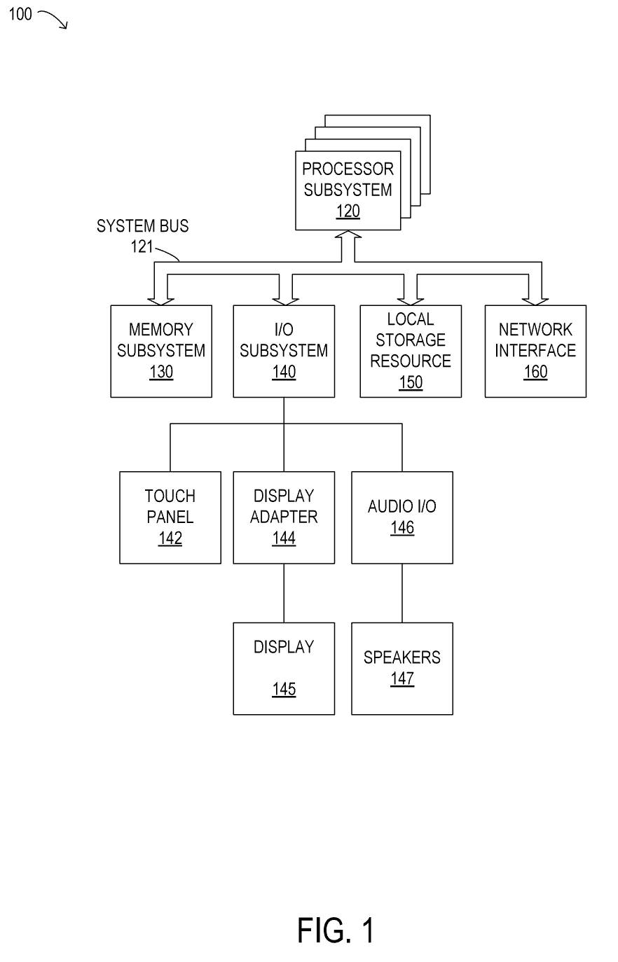

Particular embodiments are best understood by reference to FIGS. 1, 2, 3, 4A, 4B, 4C, 4D, 4E, 4F, 5, and 6 wherein like numbers are used to indicate like and corresponding parts.

Turning now to the drawings, FIG. 1 illustrates a block diagram depicting selected elements of an embodiment of information handling system 100. In various embodiments, information handling system 100 may represent a laptop-style portable system having a first body and a second body that are hingeably attached together, and may be convertible for use as a tablet or a laptop (tablet-laptop). In some embodiments, information handling system 100 may represent a desktop system in which certain components are included in a chassis enclosure. In other embodiments, information handling system 100 may represent an all-in-one system in which a computer and a flat panel display are included in a common enclosure.

As shown in FIG. 1, components of information handling system 100 may include, but are not limited to, processor subsystem 120, which may comprise one or more processors, and system bus 121 that communicatively couples various system components to processor subsystem 120 including, for example, a memory subsystem 130, an I/O subsystem 140, local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between information handling system 100 and a network (not shown). Network interface 160 may enable information handling system 100 to communicate over the network using a suitable transmission protocol and/or standard, including, but not limited to, transmission protocols and/or standards enumerated below with respect to the discussion of network 155. In some embodiments, network interface 160 may be communicatively coupled via the network to a network storage resource (not shown). The network coupled to network interface 160 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 160 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 160 and/or various components associated therewith may be implemented using hardware, software, or any combination thereof.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130). In the same or alternative embodiments, processor subsystem 120 may interpret and/or execute program instructions and/or process data stored remotely (e.g., in a network storage resource).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as information handling system 100, is powered down. Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. As shown, I/O subsystem 140 may comprise touch panel 142, display adapter 144, and audio I/O 146. Touch panel 142 may include circuitry for enabling touch functionality in conjunction with display 145 that is driven by display adapter 144. Audio I/O 146 may represent an audio adapter or interface that outputs a signal to speakers 147 and may receive a signal from an audio source, such as a microphone (not shown).

As will be described in further detail herein, speakers 147 may be implemented as one or more acoustic actuators that are bonded to an external cover of display 145, which may be a flat panel display. The acoustic actuators, responsive to receiving an audio input signal, may generate torsional waves in the external cover that, in turn, generate one or more acoustic fields. In particular embodiments, an acoustic actuator may result in an acoustic field generated at an opposite face of the flat panel display from where the acoustic actuator is bonded, such that the external cover transmits the acoustic field. In this manner a compact solution for generating quality sound from a flat panel display may be realized.

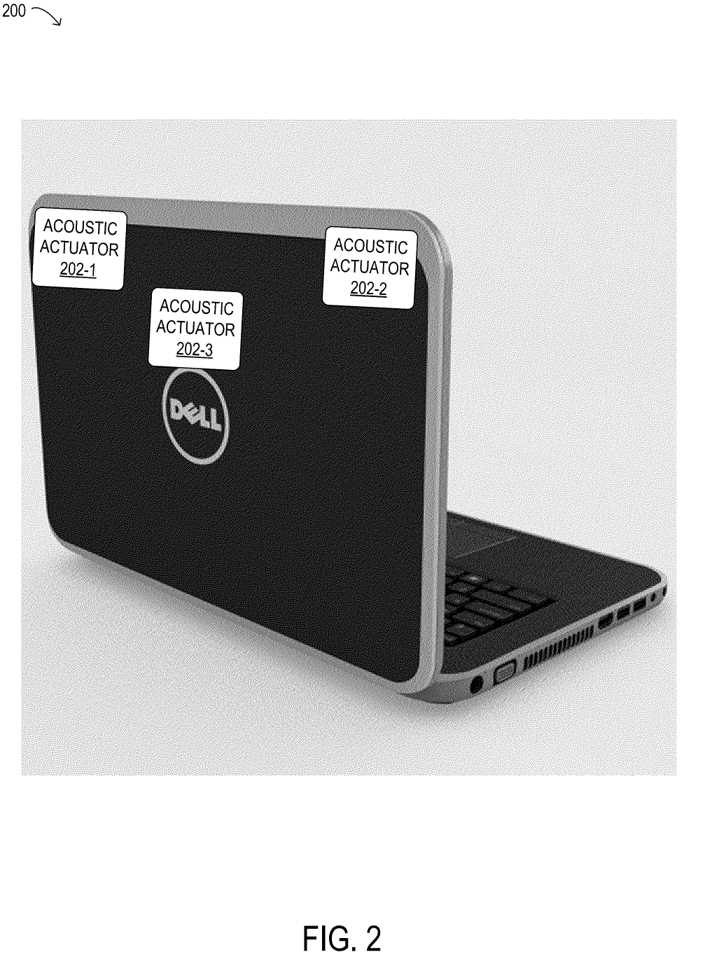

Turning now to FIG. 2, an image of selected elements of an embodiment of a flat panel display 200 with acoustic actuators 202 is illustrated. Acoustic actuators 202 may represent an embodiment of speakers 147 (see FIG. 1). In FIG. 2, placement of acoustic actuators 202 with respect to an external cover of flat panel display 200 is illustrated. Although flat panel display 200, as shown in FIG. 2, represents an embodiment in a laptop computer system, it is noted that flat panel display 200 may be implemented in various embodiments of an information handling system, such as information handling system 100 (see FIG. 1). Also, while flat panel display 200 is depicted with three acoustic actuators 202 for descriptive purposes, it is noted that in different embodiments, flat panel display 200 may be implemented with different numbers, sizes, orientations, etc. of acoustic actuators 202.

As shown in FIG. 2, flat panel display 200 includes a pair of acoustic actuators 202-1, 202-2 and a third acoustic actuator 202-3. The placement of acoustic actuators 202 in flat panel display 200 may be representative of a bonding location where acoustic actuators 202 are bonded with the external cover of flat panel display 200. In some embodiments, acoustic actuators 202 may be bonded to an exterior surface of the external cover, such that at least some of acoustic actuators 202 may be at least partially visible. In other embodiments, acoustic actuators 202 may be bonded as an intermediate and/or inner layer of the external cover, such that acoustic actuators 202 are not visible, but are included within the material used to form the external cover.

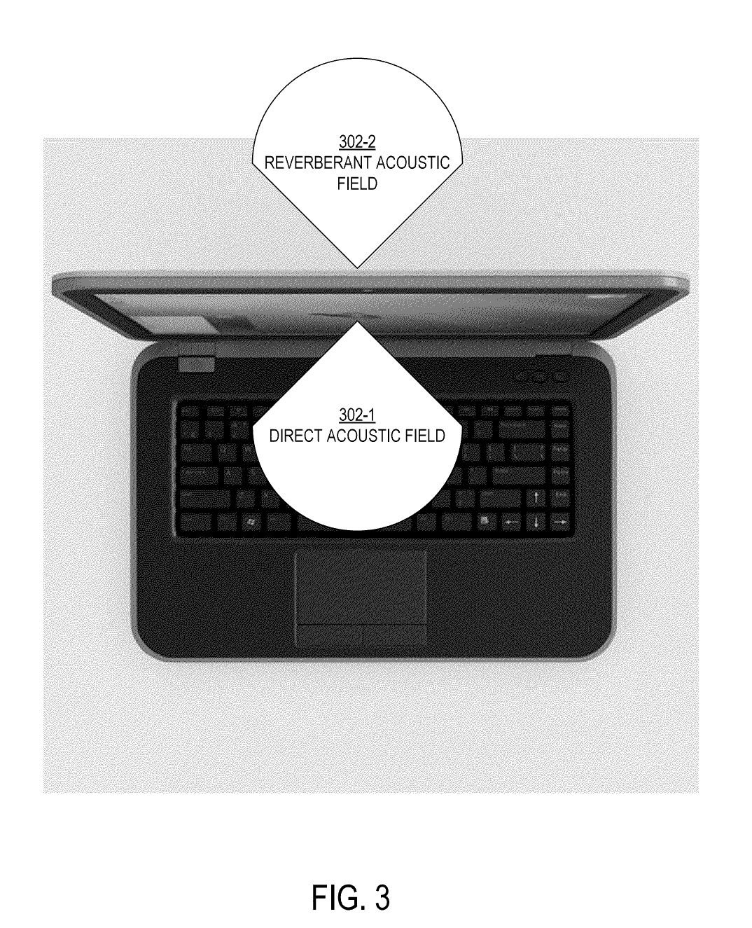

As shown in FIG. 2, acoustic actuators 202, when activated with an input signal corresponding to an audio signal, may actuate mechanically to generate torsional waves within the external cover. In various embodiments, acoustic actuators 202 may be piezoelectric elements, such as piezoelectric films. The torsional waves may be transmitted by the external cover and may result in acoustic fields being generated from surfaces of the external cover and/or the flat panel display (see also FIG. 3). Specifically, acoustic actuators 202-1, 202-1 may be bonded at respectively different corner regions of the external cover. Due to mechanical geometry, regions of the external cover proximate to a corner of the external cover (i.e., the corner regions) may exhibit increased stiffness, which may promote transmission of acoustical energy through the external cover to an opposite face of the external cover. For example, an amplitude of the acoustical energy transmitted by the external cover for a given amplitude of the input signal may depend on a stiffness of the external cover at a region proximate to acoustic actuator 202. In particular embodiments, the pair of acoustic actuators 202-1, 202-2 may result in mid-range acoustical energy being transmitted by the external cover. At the opposite face of the external cover (not visible in FIG. 2), acoustic actuators 202-1, 202-2 may result in two distinct areas (not shown) of audio transmission at corner regions of the flat panel display directed towards a user of the information handling system, which may be referred to as a direct acoustic field (see also FIG. 3). At the rear face of the external cover (visible in FIG. 2), acoustic actuators 202-1, 202-2 may result in acoustical energy being transmitted away from the user from the rear face, referred to as a reverberant acoustic field (see also FIG. 3). The two distinct areas from which the direct acoustic field and/or the reverberant acoustic field are generated by acoustic actuators 202-1, 202-2 may generate stereophonic acoustic fields, for example, when a separate right-channel input signal and a separate left channel input signal are used to drive acoustic actuators 202-1, 202-2 individually.

Furthermore, acoustic actuator 202-3 in FIG. 2 may be bonded to the external cover at a central region of flat panel display 200. In particular embodiments, acoustic actuator 202-3 may result in low-range acoustical energy being transmitted by the external cover and/or other components within flat panel display 200. As noted above with respect to acoustic actuators 202-1, 202-2, acoustic actuator 202-3 may also contribute to the direct acoustic field and/or the reverberant acoustic field (see also FIG. 3) that is experienced by the user. In various embodiments, at least some of acoustic actuators 202 may be bonded at (or proximate to) a front face of flat panel display 200, such that the external cover may also transmit acoustical energy to the rear face of the external cover, as desired.

Turning now to FIG. 3, a block diagram of selected elements of an embodiment of acoustic fields 302 is illustrated. Specifically, direct acoustic field 302-1 is shown emanating from a flat panel display in a direction towards a user, while reverberant acoustic field 302-2 is shown emanating from the flat panel display in a direction away from the user. Although reverberant acoustic field 302-2 is shown emanating away from where the user is assumed to be, the user may still experience sound from reverberant acoustic field 302-2. However, the presence of direct acoustic field 302-1 may result in a higher quality sound experience for the user than when reverberant acoustic field 302-2 is the only acoustic field. Thus, the methods and systems described herein may serve to enhance direct acoustic field 302-1 relative to reverberant acoustic field 302-2, and in this manner, to improve the sound quality generated from a flat panel display.

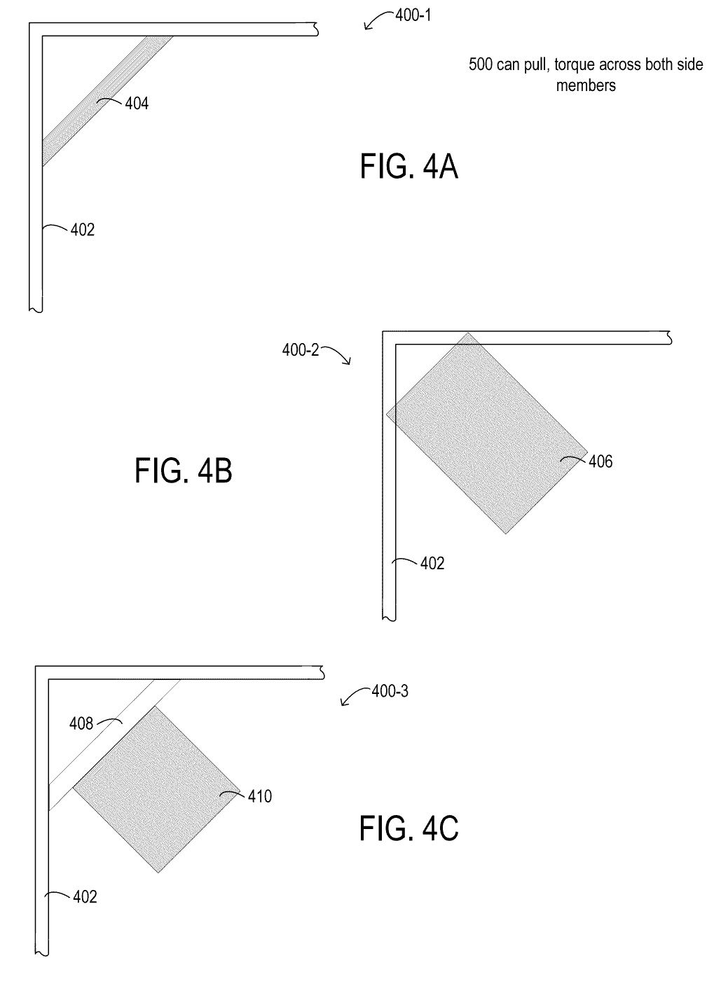

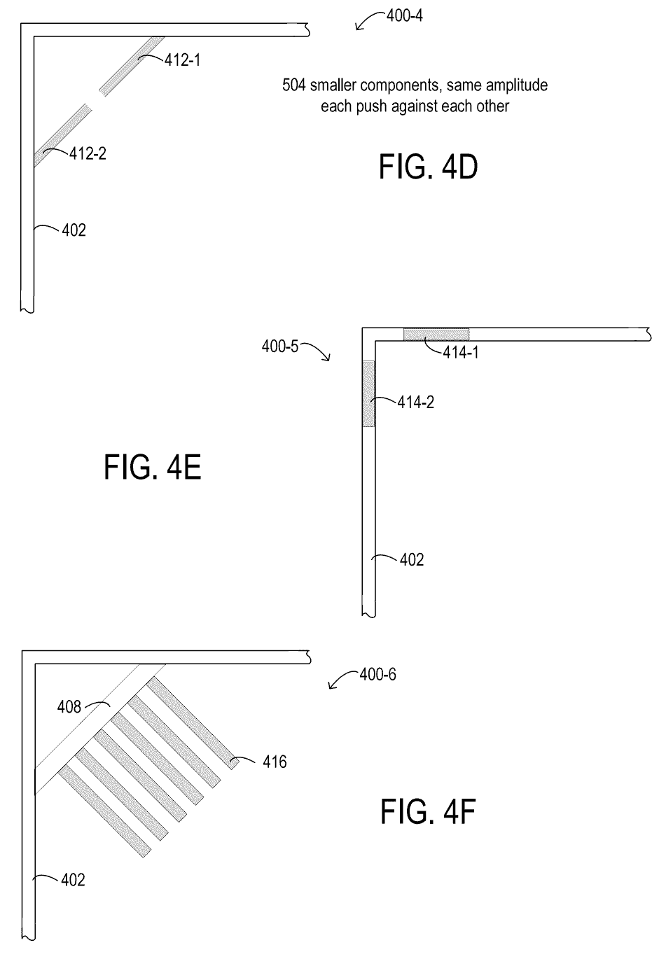

Referring now to FIGS. 4A-4F, block diagrams of selected elements of embodiments of flat panel display 400 with acoustic actuators are illustrated. Specifically, FIGS. 4A-4F depict different embodiments of acoustic actuators bonded to a corner section of flat panel display 400, represented by corner member 402, which may be a portion of an external cover of flat panel display 400. Although described with respect to a corner section, it is noted that the acoustic actuators depicted with respect to flat panel display 400 may be bonded at various positions of flat panel display 400. Flat panel display 400 may represent an embodiment of flat panel display 200 (see FIG. 2) and/or display 145 (see FIG. 1).

In FIG. 4A, flat panel display 400-1 is shown with corner member 402 having acoustic actuator 404 mounted at a corner section. Acoustic actuator 404 may be fixed to a horizontal portion and a vertical portion of corner member 402 to enable transmission of acoustical energy to an opposite face of flat panel display 400-1.

In FIG. 4B, flat panel display 400-2 is shown with corner member 402 having acoustic actuator 406 mounted at a corner section. Acoustic actuator 406 may be fixed to a horizontal portion and a vertical portion of corner member 402 to enable transmission of acoustical energy to an opposite face of flat panel display 400-2.

In FIG. 4C, flat panel display 400-3 is shown with corner member 402 having strengthening member 408 attached thereto. Strengthening member 408 may add mechanical rigidity, or stiffness, to corner member 402 and/or flat panel display 400-3. As shown in FIG. 4C, acoustic actuator 410 is mounted to strengthening member 408, which may be fixed to a horizontal portion and a vertical portion of corner member 402, to enable transmission of acoustical energy to an opposite face of flat panel display 400-3.

In FIG. 4D, flat panel display 400-4 is shown with corner member 402 having acoustic actuators 412-1 and 412-2 mounted at a corner section. Acoustic actuators 412 may be respectively fixed to a horizontal portion and a vertical portion of corner member 402 to enable transmission of acoustical energy to an opposite face of flat panel display 400-4. In FIG. 4D, acoustic actuators 412 may be made from relatively small components, to save on cost and/or space, but may deliver a sound quality and acoustic field amplitude commensurate with other embodiments of flat panel display 400. In particular, acoustic actuator 412-1 and 412-2 may mechanically work against one another to amplify a torsional wave transmitted to corner member 402.

In FIG. 4E, flat panel display 400-5 is shown with corner member 402 having acoustic actuators 414-1 and 414-2 mounted at a corner section. Acoustic actuators 414 may be respectively fixed to a horizontal portion and a vertical portion of corner member 402 to enable transmission of acoustical energy to an opposite face of flat panel display 400-5. In FIG. 4E, acoustic actuators 414 may be made from relatively small components, to save on cost and/or space, but may deliver a sound quality and acoustic field amplitude commensurate with other embodiments of flat panel display 400. In particular, acoustic actuator 414-1 and 414-2 may mechanically work against one another to amplify a torsional wave transmitted to corner member 402.

In FIG. 4F, flat panel display 400-6 is shown with corner member 402 having strengthening member 408 attached thereto. Strengthening member 408 may add mechanical rigidity, or stiffness, to corner member 402 and/or flat panel display 400-6. As shown in FIG. 4F, acoustic actuator 416 represents an array of smaller acoustic actuators that are mounted to strengthening member 408, which may be fixed to a horizontal portion and a vertical portion of corner member 402, to enable transmission of acoustical energy to an opposite face of flat panel display 400-6. In FIG. 4F, acoustic actuator 416 may be made from relatively small components, to save on cost and/or space, but may deliver a sound quality and acoustic field amplitude commensurate with other embodiments of flat panel display 400.

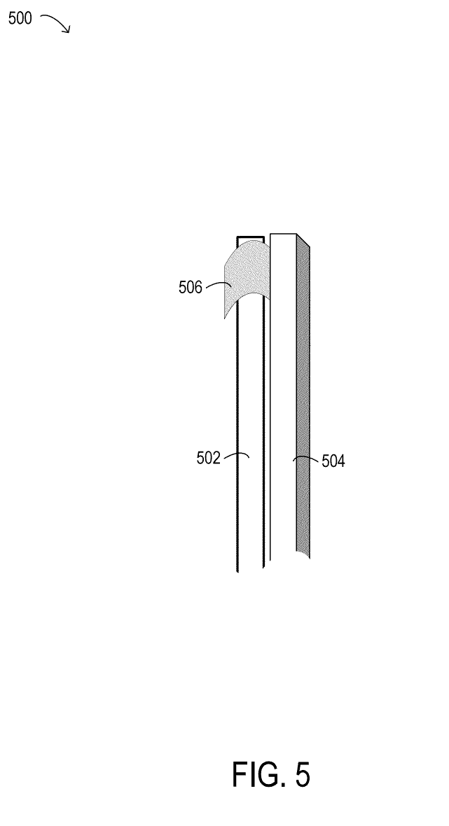

Advancing now to FIG. 5, a block diagram of selected elements of an embodiment of flat panel display 500 is illustrated. In FIG. 5, a corner portion of flat panel display 500 is shown with external cover 504 and display screen 502 from a side view. Display screen 502 may be affixed or bonded to external cover 504, among other structural elements, to form flat panel display 500. As noted previously, external cover 504 may include one or more acoustic actuators (not shown in FIG. 5) bonded thereto for quality sound generation, as described herein. In particular, external cover 504 may include acoustic waveguide 506, which may be in the form of a protrusion, a tab, a clip, a detention element, among other structures. Acoustic waveguide 506 may at least partially extend around display screen 502 to facilitate transmission of acoustical energy through flat panel display 500. In various embodiments, acoustic waveguide 506 is made from a relatively stiff material. Acoustic waveguide 506 may be integrally formed with external cover 504 or may extend into certain portions of external cover 504. In different embodiments, acoustic waveguide 506 may transmit acoustical energy generated by acoustic actuators (see FIGS. 2 and 4) around display screen 502 to an opposite face of flat panel display 500.

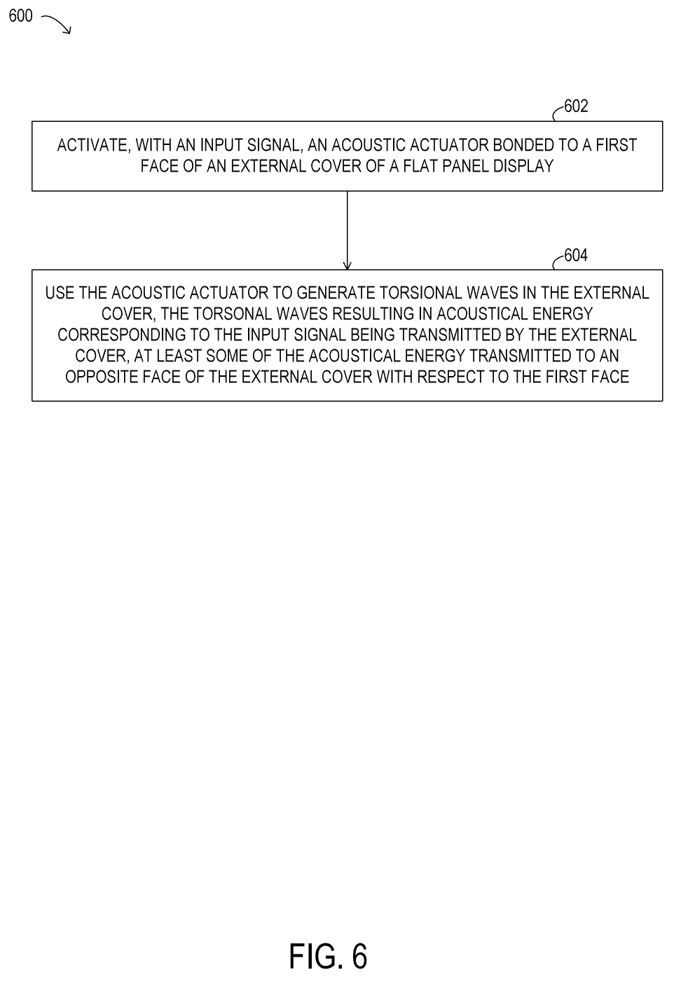

Referring now to FIG. 6, a block diagram of selected elements of an embodiment of method 600 for quality sound generation using acoustic actuators, as described herein, is depicted in flowchart form. Method 600 may be implemented by information handling system 100, display 145, and/or flat panel displays 200, 400. It is noted that certain operations described in method 600 may be optional or may be rearranged in different embodiments.

In FIG. 6, method 600 may begin by activating (operation 602), with an input signal, an acoustic actuator bonded to a first face of an external cover of a flat panel display. The input signal may be in a spectral range of 20 Hz to 20 kHz and may be selected from sound/audio signals, music signals, voice signals, and/or combinations thereof. The acoustic actuator may be used (operation 604) generate torsional waves in the external cover, the torsional waves resulting in acoustical energy corresponding to the input signal being transmitted by the external cover, where at least some of the acoustical energy is transmitted to an opposite face of the external cover with respect to the first face.

As disclosed herein, a flat panel display, such a display included in an information handling system, may have at least one acoustic actuator bonded thereto. The acoustic actuator may be driven by an audio signal and may result in acoustic fields being radiated by the flat panel display. The acoustic actuator may transmit acoustical energy through the flat panel display to an opposite face, which may result in high sound quality by generating an enhanced direct acoustic field that a user experiences.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A flat panel display, the flat panel display comprising:
an acoustic actuator enabled to receive an input signal and output acoustical energy corresponding to the input signal, wherein the acoustic actuator is bonded to a first face of an external cover of the flat panel display, wherein the external cover transmits at least some of the acoustical energy received from the acoustic actuator to a second face of the flat panel display, and wherein the second face is an opposite face with respect to the first face.

2. The flat panel display of claim 1, wherein the first face is a rear face of the external cover and the second face is a display-side face, and wherein the acoustical energy transmitted to the second face represents a direct acoustic field.

3. The flat panel display of claim 1, wherein the acoustic actuator is bonded at a corner region of the external cover.

4. The flat panel display of claim 1, wherein a first amplitude of the acoustical energy transmitted by the external cover for a given second amplitude of the input signal depends on a stiffness of the external cover at a region proximate to the acoustic actuator.

5. The flat panel display of claim 4, wherein the stiffness is enhanced by a structural member bonded to the external cover.

6. The flat panel display of claim 1, comprising:
a pair of acoustic actuators bonded at respectively different corner regions of the external cover, wherein the pair of acoustic actuators results in mid-range acoustical energy being transmitted by the external cover; and
a third acoustic actuator bonded at a central region of the external cover, wherein the third acoustic actuator results in low-range acoustical energy being transmitted by the external cover.

7. The flat panel display of claim 6, wherein the pair of acoustic actuators generates a stereophonic acoustic field.

8. The flat panel display of claim 7, wherein the stereophonic acoustic field is a direct acoustic field directed to a user.

9. The flat panel display of claim 1, wherein the acoustical energy results from a torsional wave generated by the acoustic actuator.

10. The flat panel display of claim 1, wherein the acoustical energy is in a spectral range of 20 Hz to 20 kHz and wherein the input signal is selected from: sound/audio signals, music signals, and voice signals.

11. The flat panel display of claim 1, wherein the external cover includes an acoustic waveguide that extends around a display screen included in the flat panel display.

12. A information handling system including a flat panel display, the flat panel display comprising:
an acoustic actuator enabled to receive an input signal and output acoustical energy corresponding to the input signal, wherein the acoustic actuator is bonded to a first face of an external cover of the flat panel display, wherein the external cover transmits at least some of the acoustical energy received from the acoustic actuator to a second face of the flat panel display, and wherein the second face is an opposite face with respect to the first face.

13. The information handling system of claim 12, wherein the first face is a rear face of the external cover and the second face is a display-side face, and wherein the acoustical energy transmitted to the second face represents a direct acoustic field.

14. The information handling system of claim 12, wherein the acoustic actuator is bonded at a corner region of the external cover.

15. The information handling system of claim 12, wherein a first amplitude of the acoustical energy transmitted by the external cover for a given second amplitude of the input signal depends on a stiffness of the external cover at a region proximate to the acoustic actuator.

16. The information handling system of claim 15, wherein the stiffness is enhanced by a structural member bonded to the external cover.

17. The information handling system of claim 12, comprising:
a pair of acoustic actuators bonded at respectively different corner regions of the external cover, wherein the pair of acoustic actuators results in mid-range acoustical energy being transmitted by the external cover; and
a third acoustic actuator bonded at a central region of the external cover, wherein the third acoustic actuator results in low-range acoustical energy being transmitted by the external cover.

18. The information handling system of claim 17, wherein the pair of acoustic actuators generates a stereophonic acoustic field.

19. The information handling system of claim 18, wherein the stereophonic acoustic field is a direct acoustic field directed to a user of the information handling system.

20. The information handling system of claim 12, wherein the acoustical energy results from a torsional wave generated by the acoustic actuator.

21. The information handling system of claim 12, wherein the acoustical energy is in a spectral range of 20 Hz to 20 kHz and wherein the input signal is selected from: sound/audio signals, music signals, and voice signals.

22. The information handling system of claim 12, wherein the external cover includes an acoustic waveguide that extends around a display screen included in the flat panel display.
